(19) United States
(12) Patent Application Publication
(10) Pub. No.: US 2002/0093948 A1
(43) Pub. Date: Jul. 18, 2002

(54) Packet-based multimedia communications system having one or more wireless links

(75) Inventors: Gregory A. Dertz, Algonquin, IL (US); Bradley M. Hiben, Glen Ellyn, IL (US); Donald G. Newberg, Hoffman Estates, IL (US); Kevin G. Doberstein, Elmhurst, IL (US); Robert D. LoGalbo, Hoffman Estates, IL (US); Tyrone D. Bekiares, Lake in the Hills, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/760,534

(22) Filed: Jan. 16, 2001

(51) Int. Cl. H04L 12/66; H04L 12/56; H04J 3/16; H04J 3/22

(52) U.S. Cl. 370/355; 370/401; 370/468

(57) ABSTRACT

A packet-based, multimedia communication system is disclosed that extends IP host functionality to wireless terminals serviced by wireless links. A service controller of the communication system manages communications services such as voice calls, video calls, web browsing, video-conferencing and/or internet communications over a wireless packet network between source and destination host devices. A multimedia content server of the communication system provides access to one or more requested multimedia communication services. A bandwidth manager of the communication system determines an availability of bandwidth for the service requests and, if bandwidth is available, reserves bandwidth sufficient to support the service requests. Wireless link manager(s) of the communication system manage wireless communication resources required to support the service requests. Methods are disclosed herein including the service controller managing a call request for a video/audio call; the multimedia content server accommodating a request for multimedia information (e.g., web browsing or video playback request); the bandwidth manager accommodating a request for a reservation of bandwidth to support a video/audio call; execution of a two-way video calls, video playback calls, and web browsing requests.

### CROSS REFERENCE TO RELATED APPLICATIONS

This application is related to the following U.S. Patent Applications, each of which is assigned to the assignee of the present invention and incorporated herein by reference in its entirety: Ser. No. 09/630,235, titled “Scalable Pattern Methodology for Multi-Carrier Communication Systems,” filed Aug. 1, 2000; [Atty docket #CM04755H] Ser. No. ______ , titled “Time and Bandwidth Scalable Slot Format for Mobile Data Systems,” filed Jan. 16, 2001; [Atty Docket No. CM04757H] Ser. No. ______, titled “Method and Apparatus for Determining and Reserving Bandwidth for Transmitting Delay-Sensitive Streaming Data Over a Radio Frequency Channel,” filed Jan. 16, 2001; [Atty docket #CM04761H] Ser. No. ______, titled “Method and Apparatus for Organizing and Scheduling Multimedia Data Transfers over a Wireless Channel,” filed Jan. 16, 2001; and [Atty docket #CM04762H] Ser. No. ______, titled “Slot Format and Acknowledgement Method for a Wireless Communication System,” filed Jan. 16, 2001.

### FIELD OF THE INVENTION

This invention relates generally to communication systems and, more particularly, to a packet-based communication system that is adapted to transmit multimedia (e.g., voice, data and/or video) messages over one or more wireless links.

### BACKGROUND OF THE INVENTION

Communication systems, such as land mobile radio and cellular communications systems, are well known. Such systems typically include a plurality of radio communication units (e.g., vehicle-mounted mobiles or portable radios in a land mobile system and radio/telephones in a cellular system); one or more repeaters; and dispatch consoles that allow an operator or computer to control, monitor or communicate on multiple communication resources. Typically, the repeaters are located at various repeater sites and the consoles at a console site. The repeater and console sites are typically connected to other fixed portions of the system (i.e., the infrastructure) via wire connections, whereas the repeaters communicate with communication units and/or other repeaters within the coverage area of their respective sites via a wireless link. That is, the repeaters transceive information via radio frequency (RF) communication resources, typically comprising voice and/or data resources such as, for example, narrow band frequency modulated channels, time division modulated slots, carrier frequencies, frequency pairs, etc. that support wireless communications within their respective sites.

Communication systems may be organized as trunked systems, where a plurality of communication resources is allocated amongst multiple users by assigning the repeaters within an RF coverage area on a communication-by-communication basis, or as conventional (non-trunked) radio systems where communication resources are dedicated to one or more users or groups. In trunked systems, there is usually provided a central controller (sometimes called a “zone controller”) for allocating communication resources among multiple sites. The central controller may reside within a fixed equipment site or may be distributed among the repeater or console sites.

Communication systems may also be classified as circuit-switched or packet-switched, referring to the way data is communicated between endpoints. Historically, radio communication systems have used circuit-switched architectures, where each endpoint (e.g., repeater and console sites) is linked, through dedicated or on-demand circuits, to a central radio system switching point, or “central switch.” The circuits providing connectivity to the central switch require a dedicated wire for each endpoint whether or not the endpoint is participating in a particular call. More recently, communication systems are beginning to use packet-switched networks using the Internet Protocol (IP). In packet-switched networks, the data that is to be transported between endpoints (or “hosts” in IP terminology) is divided into IP packets called datagrams. The datagrams include addressing information (e.g., source and destination addresses) that enables various routers forming an IP network to route the packets to the specified destination. The destination addresses may identify a particular host or may comprise an IP multicast address shared by a group of hosts. In either case, the Internet Protocol provides for reassembly of datagrams once they reach the destination address. Packet-switched networks are considered to be more efficient than circuit-switched networks because they permit communications between multiple endpoints to proceed concurrently over shared paths or connections.

Because packet-based communication systems offer several advantages relative to traditional circuit-switched networks, there is a continuing need to develop and/or refine packet-based communication architectures. Historically, however, particularly for packet-based radio and cellular communications systems, the endpoints or “hosts” of the IP network comprise repeaters or consoles. Thus, the IP network does not extend across the wireless link(s) to the various communication units. Existing protocols used in IP transport networks such as, for example, H.323, SIP, RTP, UDP and TCP neither address the issue nor provide the functionality needed for sending multimedia data (particularly time-critical, high-frame-rate streaming voice and video) over the wireless link(s). Thus, any packets that are to be routed to the communication units must be tunneled across the wireless link(s) using dedicated bandwidth and existing wireless protocols such as the APCO-25 standard (developed by the U.S. Association of Public Safety Communications Officers (APCO)) or the TETRA standard (developed by the European Telecommunications Standards Institute (ETSI)). Presently, however, none of these protocols are sufficiently able to accommodate the high speed throughput of packet data that is needed to fully support multimedia communications.

Accordingly, there is a need for a communication system that extends packet transport service across the wireless link(s), or stated differently, that extends IP “host” functionality to wireless communication units so as not to require dedicated bandwidth between endpoints. Advantageously, the communication system and protocol will support high-speed throughput of packet data, including but not limited to streaming voice and video over the wireless link. The present invention is directed to addressing these needs.

### BRIEF DESCRIPTION OF THE DRAWINGS

The foregoing and other advantages of the invention will become apparent upon reading the following detailed description and upon reference to the drawings in which:

FIG. 1 is a block diagram of a packet-based multimedia communication system according to one embodiment of the present invention;

FIG. 2 is a flowchart illustrating steps performed by a service controller of the packet-based multimedia communication system of the present invention;

FIG. 3 is a flowchart illustrating steps performed by a bandwidth manager of the packet-based multimedia communication system of the present invention;

FIG. 4 is a flowchart illustrating steps performed by a wireless link manager of the packet-based multimedia communication system of the present invention;

FIG. 5 is a flowchart illustrating steps performed by a wireless terminal of the packet-based multimedia communication system of the present invention;

FIG. 6 is a flowchart illustrating steps performed by a multimedia content server of the packet-based multimedia communication system of the present invention;

FIG. 7 is a message sequence chart associated with one embodiment of a two-way video call supported by the packet-based multimedia communication system of the present invention;

FIG. 8 is a message sequence chart associated with one embodiment of a one-way video playback call supported by the packet-based multimedia communication system of the present invention; FIG. 9 is a message sequence chart associated with a second embodiment of a one-way video playback call supported by the packet-based multimedia communication system of the present invention; and

FIG. 10 is a message sequence chart associated with one embodiment of a web browsing request supported by the packet-based multimedia communication system of the present invention.

### DESCRIPTION OF PREFERRED EMBODIMENTS

The following describes a communication system that extends packet transport service over both wireline and wireless link(s). The communication system supports high-speed throughput of packet data, including but not limited to streaming voice and video between IP host devices including but not limited to wireless communication units.

In one embodiment of the present invention, there is provided a communication system comprising a wireless packet network, a plurality of host devices and a service controller. The wireless packet network includes at least one wireless link. The service controller manages one or more communications services such as voice calls, video calls, web browsing, video-conferencing and/or internet communications over the wireless packet network between source and destination host devices. The source and/or destination devices may comprise wireless terminals.

In another embodiment of the present invention, there is provided a communication system comprising a wireless packet network, a multimedia content server, a service controller, a bandwidth manager and a wireless link manager. The service controller and bandwidth manager may be embodied in a single gatekeeper device coupled to the wireless packet network. The multimedia content server has access to one or more requested multimedia communication services. The service controller manages service requests associated with the one or more requested multimedia communication services. The bandwidth manager determines an availability of bandwidth for the service requests and, if bandwidth is available, reserves bandwidth sufficient to support the service requests. The wireless link manager manages wireless communication resources required to support the service requests.

In still another embodiment of the present invention, there is provided a method comprising a service controller of a wireless packet network receiving, from a requesting device, a call request for a type of video/audio call. The video/audio call may comprise a two-way video, one-way video, two-way audio, one-way audio, two-way audio and video, one-way audio and video or two-way audio and one-way video call. Upon receiving information identifying source and destination devices associated with the call, the service controller requests a reservation of bandwidth to support the call and, if the reservation is available, authorizes the call to proceed. If the reservation is not available, the service controller rejects the call request. Optionally, the service controller may reject the call request if the source or destination device is not authorized to participate in the call.

In yet another embodiment of the present invention, there is provided a method comprising a multimedia content server of a wireless packet network receiving, from a requesting device, a request for multimedia information to be delivered to a destination device. The multimedia content server retrieves the requested multimedia information and sends the requested multimedia information to the destination device. Optionally, the request may comprise a web browsing, audio and/or video playback request. If the request is a video playback request, the multimedia content server requests authorization for a video call from a service controller and negotiates terms of the video call with the destination device before sending video information associated with the video playback request to the destination device.

In still yet another embodiment of the present invention, there is provided a method comprising a bandwidth manager of a wireless packet network receiving, from a requesting device (e.g., service controller), a request for a reservation of bandwidth to support a video/audio call. The bandwidth manager determines an amount of bandwidth required for the call and grants or denies the reservation based on an availability of bandwidth to support the call. If the video/audio call is to be routed across wireless link(s), the bandwidth manager reserves wireless communication resources with wireless link manager(s). When the call is ended, the bandwidth manager coordinates a release of bandwidth and/or wireless communication resources used for the call.

In a still further embodiment of the invention, there is provided a method comprising a video server of a wireless packet network receiving, from a requesting device, a request for video playback to a destination device. The video server retrieves one or more packets of video information associated with the request for video playback and, if authorization is received from a service controller, sends the one or more packets to the destination device.

In still another embodiment of the present invention, there is provided a method comprising a wireless terminal of a wireless packet network receiving information via a wireless link, the information comprising either an assignment granting permission for the wireless terminal to send an inbound message (outbound with respect to the wireless terminal) over the wireless link, or to present an outbound message (inbound w/r to the wireless terminal) to a user of the wireless terminal. If the information is an assignment, the wireless terminal sends the inbound message over the wireless link. If the information is an outbound message, the wireless terminal presents the outbound message to the user.

In still yet another embodiment of the invention, there is provided a method of executing a two-way video call in a wireless packet network communication system between a first and second wireless terminal. The method comprises a service controller receiving a call request for the two-way video call from the first wireless terminal that identifies the second wireless terminal. The service controller determines an availability of bandwidth to support the call and, if bandwidth is available, sends a message to the first wireless terminal authorizing the call to proceed. Optionally, the determination of availability of bandwidth may be accomplished by the service controller in communication with a bandwidth manager. The bandwidth manager requests a reservation of wireless communication resources for the call from first and second wireless link managers. Optionally, the two-way video call may be executed between a first wireless terminal and a first wired terminal. In such case, only a first wireless link manager is required.

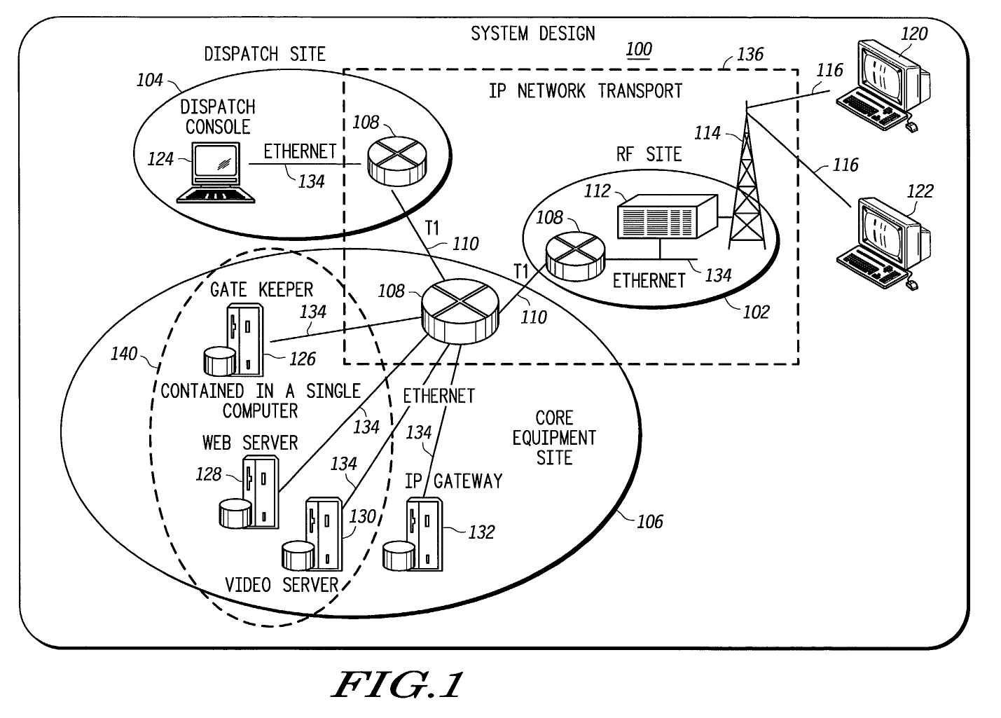

Turning now to the drawings and referring initially to FIG. 1, there is shown a packet-based multimedia communication system (“network”) 100 comprising a repeater site 102, console site 104 and core equipment site 106 having associated routers 108 interconnected by T1 links 110. Alternatively, the T1 links may be replaced or used in combination with T3 links, optical links, or virtually any type of link adapted for digital communications. The repeater site 102 includes a repeater 112 and antenna 114 that is coupled, via wireless communication resources 116 with communication units 120, 122 within its geographic coverage area. The console site 104 includes a dispatch console 124. As shown, the dispatch console 124 is a wireline console. However, it will be appreciated that the console may be a wireless or wireline console. The core equipment site 106 includes a gatekeeper 126, web server 128, video server 130 and IP Gateway 132. The devices of the core equipment site 106 will be described in greater detail hereinafter. As will be appreciated, the packet-based multimedia communication system 100 may include multiple repeater sites, console sites and/or core equipment sites, having fewer or greater numbers of equipment, having fewer or greater numbers of routers or communication units or having equipment distributed among the sites in a different manner than shown in FIG. 1.

In one embodiment, the communication units 120, 122 comprise wireless radio terminals that are equipped for one-way or two-way communication of IP datagrams associated with multimedia calls (e.g., voice, data and/or video, including but not limited to high-speed streaming voice and video) singly or simultaneously with other hosts in the communication system 100. In such case, the communication units 120, 122 include the necessary call control, voice and video coding, and user interface needed to make and receive multimedia calls. As will be appreciated, however, the communication units may comprise virtually any mobile or portable wireless radio units, cellular radio/telephones or devices having varying capacities to accommodate multimedia calls. For example, it is envisioned that some communication units may be able to transceive voice and data, not video; other communication units may be able to receive but not transmit video, and so forth.

In one embodiment, the repeater 112, communication units 120, 122, routers 108, dispatch console 124, gatekeeper 126, web server 128, video server 130 and IP Gateway 132 all comprise IP host devices that are able to send and receive IP datagrams between other host devices of the network. For convenience, the communication units 120, 122 will be referred to as “wireless terminals.” As will be appreciated, the wireless terminals may also include wireless consoles or other types of wireless devices. All other host devices of FIG. 1 will be referred to as “fixed equipment” host devices. Each host device has a unique IP address. The host devices include respective processors (which may comprise, for example, microprocessors, microcontrollers, digital signal processors or combination of such devices) and memory (which may comprise, for example, volatile or non-volatile digital storage devices or combination of such devices).

In one embodiment, the fixed equipment host devices at the respective sites are connected to their associated routers 108 via wireline connections (e.g., Ethernet links 134) and the routers themselves are also connected by wireline connections (e.g., T1 links). These wireline connections thus comprise a wireline packet switched infrastructure (“packet network”) 136 for routing IP datagrams between the fixed equipment host devices. One of the unique aspects of the present invention is the extension of IP host functionality to the wireless host devices (e.g., the communication units 120, 122) over a wireless link (i.e., the wireless communication resource 116). For convenience, the term “wireless packet network” will hereinafter define a packet network that extends over at least one wireless link to a wireless host device as described herein.

The wireless communication resource 116 may comprise multiple RF (radio frequency) channels such as pairs of frequency carriers, code division multiple access (CDMA) channels, or any other RF transmission media. The repeater 112 is used to generate and/or control the wireless communication resource 116. In one embodiment, the wireless communication resource 116 comprises time division multiple access (TDMA) slots that are shared by devices receiving and/or transmitting over the wireless link. IP datagrams transmitted across the wireless link can be split among multiple slots by the transmitting device and reassembled by the receiving device.

In one embodiment, the repeater 112 performs a wireless link manager function and a base station function. The wireless link manager sends and receives datagrams over the wireline network 136, segments and formats datagrams for transmission over the wireless link 116, prioritizes data for transmission over the wireless link 116 and controls access of the wireless terminals 120, 122 to the wireless link 116. In one embodiment, the latter function is accomplished by the wireless link manager allocating “assignments” granting permission for the wireless terminals to send messages over the wireless link. The assignments may comprise either “Non-Reserved Assignment(s)” or “Reserved Assignments,” each of which is described in greater detail in related application Ser. No.______, [docket no. CM04761H]. The base station sends and receives radio signals over the wireless link 116. Multiple base stations can be attached to a single wireless link manager.

Related application Ser. No.______, [docket no. CM04762H] discloses a slot structure that supports the transmission of multiple types of data over the wireless link 116 and allows the packets of data to be segmented to fit within TDMA slots. It also provides for different acknowledgement requirements to accommodate different types of service having different tolerance for delays and errors. For example, a voice call between two wireless terminal can tolerate only small delays but may be able to tolerate a certain number of errors without noticeably effecting voice quality. However, a data transfer between two computers may require error-free transmission but delay may be tolerated. Advantageously, the slot format and acknowledgement method may be implemented in the present invention to transmit delay-intolerant packets on a priority basis without acknowledgements, while transmitting error-intolerant packets at a lower priority but requiring acknowledgements and retransmission of the packets when necessary to reduce or eliminate errors. The acknowledgement technique may be asymmetric on the uplink (i.e., wireless terminal to repeater) and downlink (i.e., repeater to wireless terminal) of the wireless link 116.

The routers 108 of the wireline portion of the network are specialized or general purpose computing devices configured to receive IP packets or datagrams from a particular host in the communication system 100 and relay the packets to another router or another host in the communication system 100. The routers 108 respond to addressing information in the IP packets received to properly route the packets to their intended destination. In accordance with internet protocol, the IP packets may be designated for unicast or multicast communication. Unicast is communication between a single sender and a single receiver over the network. Multicast is communication between a single sender and multiple receivers on a network. Each type of data communication is controlled and indicated by the addressing information included in the packets of data transmitted in the communication system 100. For a unicast message, the address of the packet indicates a single receiver. For a multicast communication, the address of the packet indicates a multicast group address to which multiple hosts may join to receive the multicast communication. In such case, the routers of the network replicate the packets, as necessary, and route the packets to the designated hosts via the multicast group address.

The wireless packet network is adapted to transport IP packets or datagrams between two or more hosts in the communication system 100, via wireless and/or wireline links. In a preferred embodiment, the wireless packet network will support multimedia communication, including but not limited to high-speed streaming voice and video so as to provide the hosts of the communication system 100 with access to voice, video, web browsing, video-conferencing and internet applications. As will be appreciated, depending on which host devices are participating in a call, IP packets may be transported in the wireless packet network over wireline portions, wireless portions or both wireline and wireless portions of the network. For example, IP packets that are to be communicated between fixed equipment host devices (e.g., between console 124 and gatekeeper 126) will be routed across only wireline links, and IP packets that are communicated between fixed equipment host devices and wireless communication devices are transported across both wireline and wireless links. Those packets that are to be communicated between wireless terminals (e.g., between communication units 120, 122) may be transported across only wireless links, or wireless and wireline links, depending on the mode of operation of the communication system 100. For example, in site trunking mode, packets might be sent from communication unit 120 to repeater site 102 via wireless link 116, to router 108 via Ethernet 134, back to the repeater site 102 and then to communication unit 122 via wireless link 118. In a direct mode, sometimes referred to as “talk around” mode, packets may be sent between the communication units 120, 122 directly via a wireless link. In either case, the wireless packet network of the present invention is adapted to support multimedia communication, including but not limited to high-speed streaming voice and video so as to provide the host devices with access to voice, video, web browsing, video-conferencing and internet applications.

Practitioners skilled in the art will appreciate that the communication system 100 may include various other communication devices not shown in FIG. 1. For example, the communication system 100 may include comparator(s), telephone interconnect device(s), internet protocol telephony device(s), call logger(s), scanner(s) and gateway(s). Generally, any of such communication devices may comprise wireless or fixed equipment host devices that are capable of sending or receiving IP datagrams routed through the communication system 100. These devices are described briefly below.

A comparator (or “voter”) is a device, usually connected by wireline to various receivers (e.g., different repeaters) receiving different instance(s) of a particular message or signal (e.g., from a subscriber radio unit). The comparator receives and compares among the different instances of the signal that may be received by the different receivers, and produces an output message that is comprised of either an entire message from one of the receivers or a composite message comprised of segments of the message received from one or more of the receivers. Each message may be comprised of a plurality of message frames.

A scanner is a receiver that is adapted to monitor message transmissions from communication devices such as mobile or portable wireless radio units, consoles, repeaters, and the like. In one mode of operation, for example, a scanner scans the radio spectrum for the purpose of finding and, optionally, locking on to carrier frequencies containing message transmissions. Scanners are often used by parties that are not intended recipients of the message transmissions.

A telephone interconnect device is a network-based device that provides voice transcoding services between mobile and land line subscribers when invoking fall duplex telephone calls between those two subscribers. A transcoding service is required, for example, when a mobile subscriber using IMBE vocoding requests a call to a subscriber in the public switched telephone network (PSTN) using 64-kilobit per second PCM vocoding.

An internet protocol telephony device comprises a telephone that transports voice and/or control messages over a LAN to a telephony gateway box, which interfaces multiple (LAN based) phones and converts the IP control and audio packets back into the format of the local PSTN. More generally, a gateway device is one that provides voice and control translation services between two dissimilar communication systems. For example, a gateway device would be required if an APCO system were to be connected to a GSM system. Other services such as feature translation, authentication, authorization and encryption could also be provided by a gateway device.

A call logger is a networked based device that records, for example, packetized voice talkgroup and private calls in a public safety system. A call logger could also record data calls, video, and/or location (e.g., GPS) data streams. A call logger device typically stores the voice payload in its native format (e.g., vocoded audio). When it is desirable to playback the voice conversation at a later time, the call logger retrieves and decodes all packets which bound the call in question.

Now referring to the core equipment site 106, the gatekeeper 126, web server 128, video server 130 and IP Gateway 132 will be described in greater detail. Generally, the gatekeeper 126, web server 128, video server 130 and IP Gateway 132 operate either singly or in combination to control audio and/or video calls, streaming media, web traffic and other IP datagrams that are to be transported over a wireless portion of the communication system 100. In one embodiment, the gatekeeper 126, web server 128 and video server 130 are functional elements contained within a single device, designated in FIG. 1 by the dashed bubble 140. It will be appreciated, however, that the gatekeeper 126, web server 128 and/or video server 130 functions may be distributed among separate devices.

According to one embodiment of the present invention, the gatekeeper 126 authorizes all video and/or audio calls between host devices within the communication system 100. For convenience, the term “video/audio calls” will be used herein to denote video and/or audio calls. The video/audio calls that must be registered with the gatekeeper are one of three types: video only, audio only, or combination audio and video. Calls of either type can be two-way, one-way (push), one-way (pull), or a combination of one-way and two-way. Two-way calls define calls between two host devices wherein host devices sends audio and/or video to each other in full duplex fashion, thus providing simultaneous communication capability. One-way push calls define calls in which audio and/or video is routed from a source device to a destination device, typically in response to a request by the source device (or generally, by any requesting device other than the destination device). The audio and/or video is “pushed” in the sense that communication of the audio and/or video to the destination device is initiated by a device other than the destination device. Conversely, one-way pull calls define calls in which audio and/or video is routed from a source device to a destination device in response to a request initiated by the destination device.

In one embodiment, any communication between host devices other than video/audio calls including, for example, control signaling or data traffic (e.g., web browsing, file transfers) may proceed without registering with the gatekeeper 126. As has been noted, the host devices may comprise wireless devices (e.g., communication units 120, 122) or fixed equipment devices (e.g., repeater 112, routers 108, console 124, gatekeeper 126, web server 128, video server 130 and IP Gateway 132).

For video/audio calls, the gatekeeper 126 determines, cooperatively with the host device(s), the type of transport service and bandwidth needed to support the call. In one embodiment, for example, this is accomplished by the gatekeeper exchanging control signaling messages with both the source and destination device. If the call is to be routed over a wireless link, the gatekeeper determines the RF resources 116 needed to support the call and reserves those resources with the wireless link manager (a functional element of repeater 112). The gatekeeper 126 further monitors the status of active calls and terminates a call, for example when it determines that the source and/or recipient devices are no longer participating in the call or when error conditions in the system necessitate terminating the call. The wireless link manager receives service reservation commands or requests from the gatekeeper and determines the proper combination of error correction techniques, reserved RF bandwidth and wireless media access controls to support the requested service. The base station is able to service several simultaneous service reservations while sending and receiving other IP traffic between the communication units 120, 122 and host device(s) over the wireless link 116.

The web server 128 provides access to the management functions of the gatekeeper 126. In one embodiment, the web server 128 also hosts the selection of video clips, via selected web pages, by a host device and provides the selected streaming video to the video server 130. The video server 130 interfaces with the web server 128 and gatekeeper 126 to provide stored streaming video information to requesting host devices. For convenience, the combination of web server 128 and video server 130 will be referred to as a multimedia content server 128, 130. The multimedia content server 128, 130 may be embodied within a single device 140 or distributed among separate devices. The IP gateway 132 provides typical firewall security services for the communication system 100.

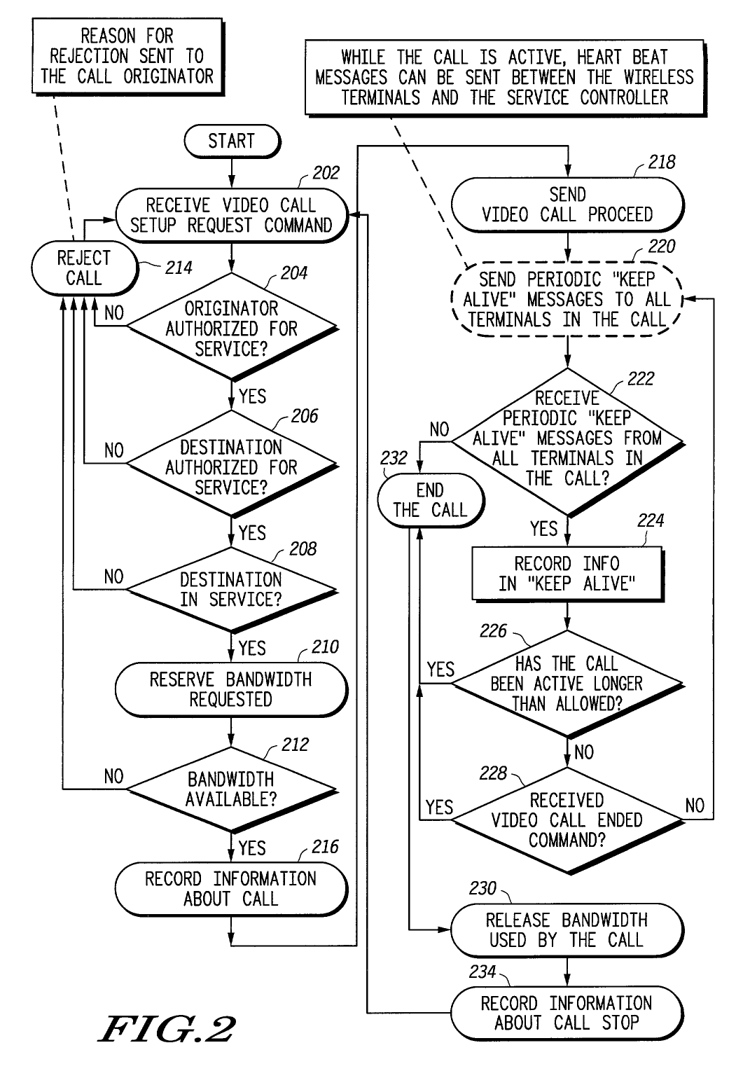

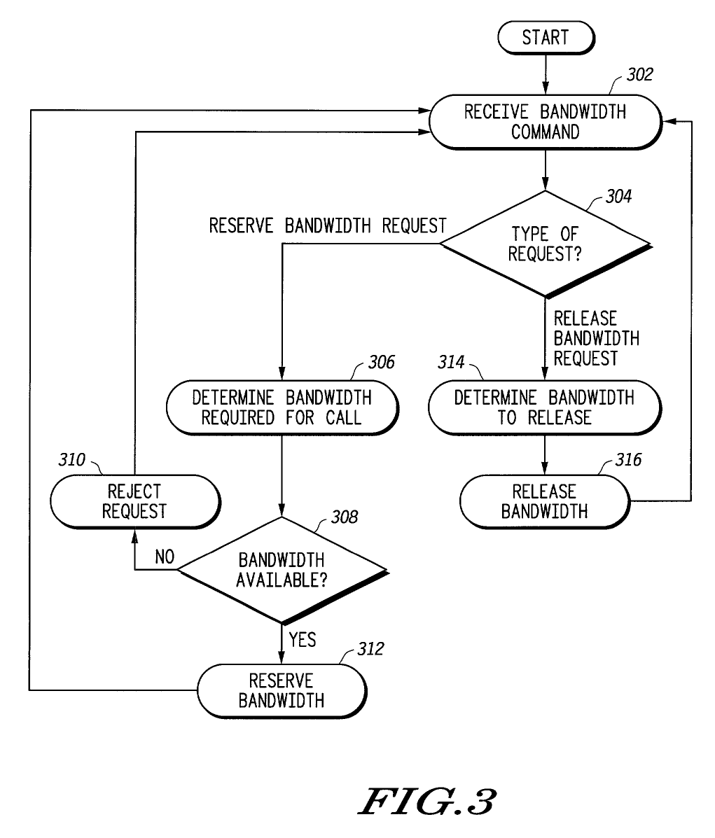

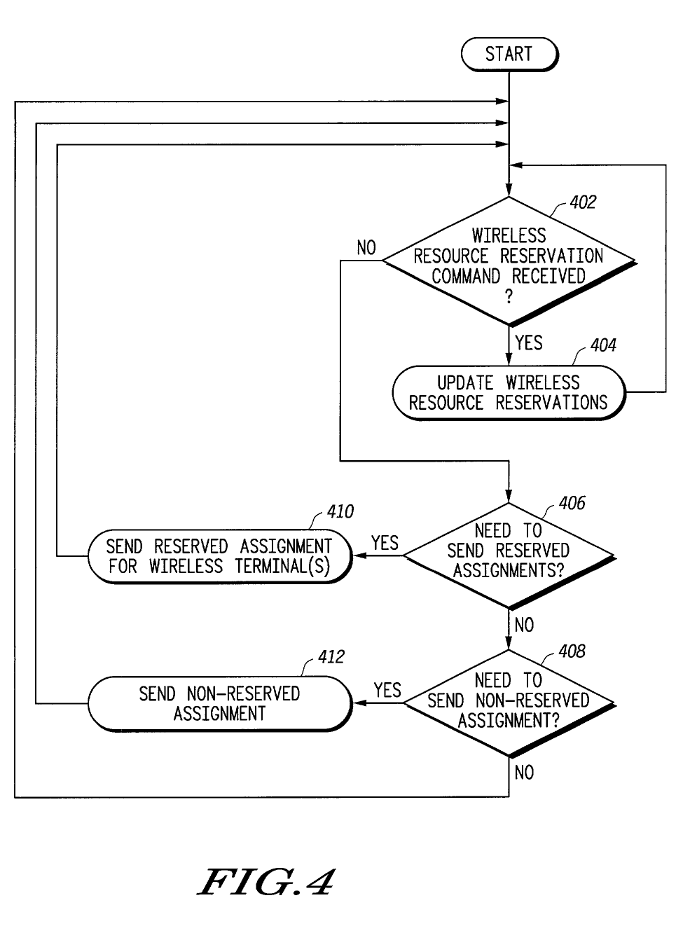

FIGS. 2 and 3, respectively, are flowcharts associated with a service controller element and bandwidth management element of the communication system 100. In one embodiment, the service controller element and bandwidth management element are functional elements contained within the gatekeeper 126. For convenience, the terms “service controller” and “bandwidth manager,” respectively, will denote the service controller function and bandwidth management function of the gatekeeper 126. The flowcharts of FIG. 2 and FIG. 3 illustrate steps performed by the service controller and bandwidth manager, respectively, for a single call request. As will be appreciated, however, the service controller and bandwidth manager can accommodate multiple, simultaneous call requests.

Referring initially to FIG. 2, step 202, the service controller receives a video call setup request from a requesting host device. The requesting device may comprise any host device of the communication system 100 including, for example, the wireless terminals 120, 122, the multimedia content server 128, 130 or console 124. In one embodiment, the call request identifies a type of video/audio call (e.g., video only, audio only, combination audio/video, either of which may be two-way, one-way (push), one-way (pull), or combination one-way and two-way) and a source and destination device for the call. The source and destination devices may be the same or different than the requesting device.

The present invention contemplates that the source and/or destination devices may be authorized for certain services and not authorized for others. For example, a particular wireless terminal may be authorized for audio but not video calls. In one embodiment, the service controller determines at step 204 if the source device is authorized to participate in the requested service and determines at step 206 if the destination device is authorized to participate in the requested service. If either the source or destination device is not authorized for the service, the service controller rejects the call at step 214. In the embodiment of FIG. 2, the service controller also determines whether the destination device is “in service” or otherwise is operable to receive the requested service at step 208. If the destination device is not in service, the service controller rejects the call at step 214.

If the service controller determines that the source and destination devices are authorized for service at steps 204, 206 and that the destination device is in service at step 208, the service controller requests a reservation of bandwidth to support the call at step 210. In one embodiment, this comprises the service controller sending a request for a reservation of bandwidth to the bandwidth manager. In one embodiment, the service controller may also request a modification or update to an already-granted reservation of bandwidth. For example, the service controller might dynamically scale video bitrates of active calls depending on system load.

As will be described in greater detail in relation to FIG. 3, the bandwidth manager grants or denies the reservation (or reservation update) based on an availability of bandwidth to support the call on wireline and/or wireless links. The service controller determines at step 212 whether bandwidth is available to support the call based on the response from the bandwidth manager. If bandwidth is not available, the service controller rejects the call at step 214 and, in one embodiment, sends a message to the call originator identifying reason(s) for the rejection.

If bandwidth is available, the service controller records information about the call at step 216 including, for example, start time, source address, destination address, type of call, resources requested, bit rate, etc. and at step 218, sends a message to the source device authorizing the call to proceed.

Optionally, at step 220, the service controller sends periodic “heart beat” or “keep alive” messages indicative of call activity (or call authorization) to the source and destination devices until the call is ended at step 232. The source and destination devices further send periodic messages indicative of call activity to the service controller and optionally, to each other. Information from the “keep alive” messages is recorded at step 224. The service controller may end the call at step 232 if it stops receiving the keep alive messages (step 222), if the duration of the call exceeds an allowable time limit (step 226) or if it receives a “call end” command (step 228) indicating that a participating device desires to end the call. In one embodiment, “call end” commands causing the service controller to end the call may be sent by either the source device or the destination device. If the call is ended, the service controller requests at step 230, from the bandwidth manager, a release of bandwidth supporting the call and at step 234, records information about the stop of the call. The information recorded at step 234 may comprise, for example, end time, source address, destination address, type of call, resources used, bit rate, etc.

Now turning to FIG. 3, there will be described various steps performed by the bandwidth manager according to one embodiment of the invention. At step 302, the bandwidth manager receives a bandwidth command, or request, from the service controller. In one embodiment, the request may comprise a request for reservation of bandwidth for an impending call, a request for modification to an existing reservation or a request for a release of bandwidth for a call that has ended. The bandwidth manager determines the type of request at step 304.

If the request is for a reservation of bandwidth, the bandwidth manager determines at step 306 an amount of bandwidth required for the call. In one embodiment, the wireline portion of the network is sized to accommodate worst-case loading scenarios, thus at step 306 the bandwidth manager is not concerned with the bandwidth required or used on the wireline link(s), but rather is concerned only with the bandwidth that is required for the wireless link(s). Alternatively, the bandwidth manager may determine an amount of bandwidth required on both wireless and wireline link(s). The required bandwidth may differ according to the type of call (e.g., video vs. audio calls) and/or characteristics of the call including, for example, the bit rate, packet size, codec type, etc. The bandwidth manager determines whether the required bandwidth is available at step 308. If the required bandwidth is not available, the bandwidth manager rejects the request for a reservation of bandwidth at step 310. If the required bandwidth is available, the bandwidth manager reserves the bandwidth at step 312 and sends a message to the service controller indicating that the bandwidth reservation is granted.

One manner of determining availability of bandwidth and obtaining bandwidth reservations for wireless links of the communication system 100 is described and claimed in related application Ser. No.______, [Atty Docket No. CM04757H]. Upon receiving a reservation request for a particular call, the bandwidth manager determines the number of slots per second that will be required to carry IP packets associated with the call over a wireless link. The required slots/second is dependent on, among other things, the bit rate, frame rate, encoder/decoder type or other parameter related to the requested application. After the channel requirements are determined, the bandwidth manager determines if the wireless link(s), including existing loading, can accommodate the channel requirements associated with the request. If the requested bandwidth is available, the bandwidth manager commands the appropriate wireless link manager(s) at step 312 to reserved the required bandwidth on the wireless link(s). If, at step 304, the request is for a release of bandwidth, the bandwidth manager determines at step 314 an amount of bandwidth associated with the request, i.e., an amount of bandwidth to be released. Then, at step 316, the bandwidth manager commands the appropriate wireless link manager(s) to release the bandwidth so that it is available for future calls.

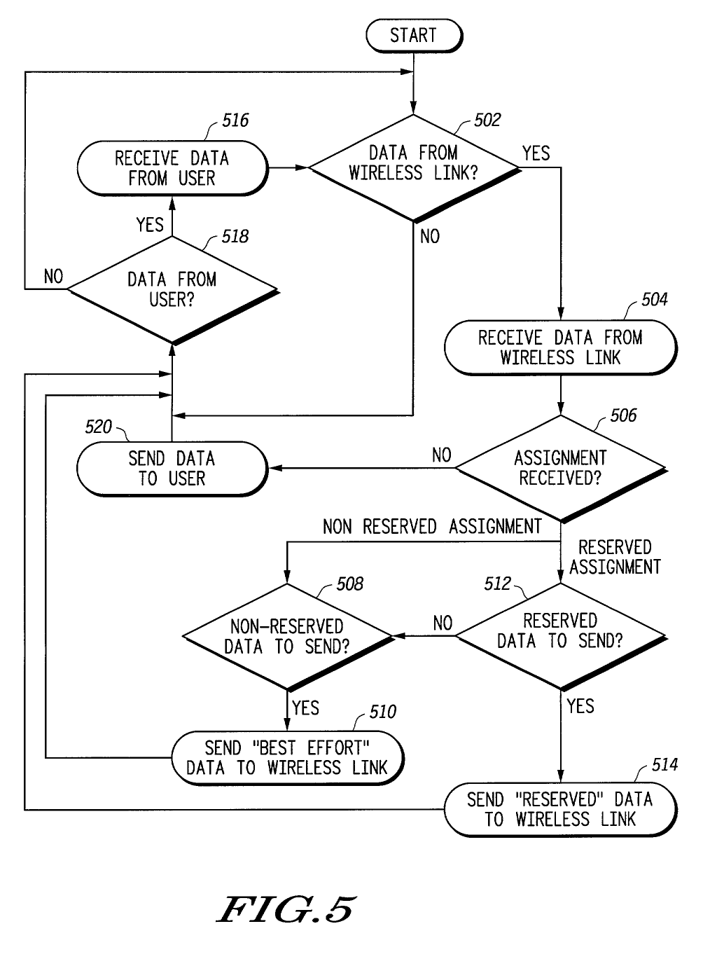

FIG. 4 is a flowchart associated with a wireless link manager of the packet-based multimedia communication system 100. In one embodiment, each repeater 112 of the communication system 100 includes a wireless link manager to manage an associated wireless link. At step 402, the wireless link manager determines whether it has received a wireless resource reservation command. In one embodiment, as described in relation to FIG. 3, the command may comprise a reserve bandwidth command, a modify reservation command or release bandwidth command from a bandwidth manager of the communication system. If, at step 402, the wireless link manager has received a wireless resource reservation command, it executes the command (e.g., to reserve bandwidth, modify a reservation or release bandwidth) and updates wireless link reservations as appropriate at step 404.

If the wireless link manager has not received a wireless resource reservation command, it determines at step 406 whether to send Reserved Assignment(s) to any affiliated wireless terminals. If the wireless link manager determines at step 406 not to send Reserved Assignments, it determines at step 408 whether to send Non-Reserved Assignment(s) to any affiliated wireless terminals. In response to a positive determination at step 406, the wireless link manager sends Reserved Assignment(s) for affiliated wireless terminals at step 410. Similarly, in response to a positive determination at step 408, the wireless link manager sends Non-Reserved Assignment(s) for affiliated wireless terminals at step 412. The determination of whether and/or when the wireless link manager should send Reserved Assignment(s) or Non-Reserved Assignments is described in related application Ser. No.______, [docket no. CM04761H], incorporated herein by reference in its entirety.

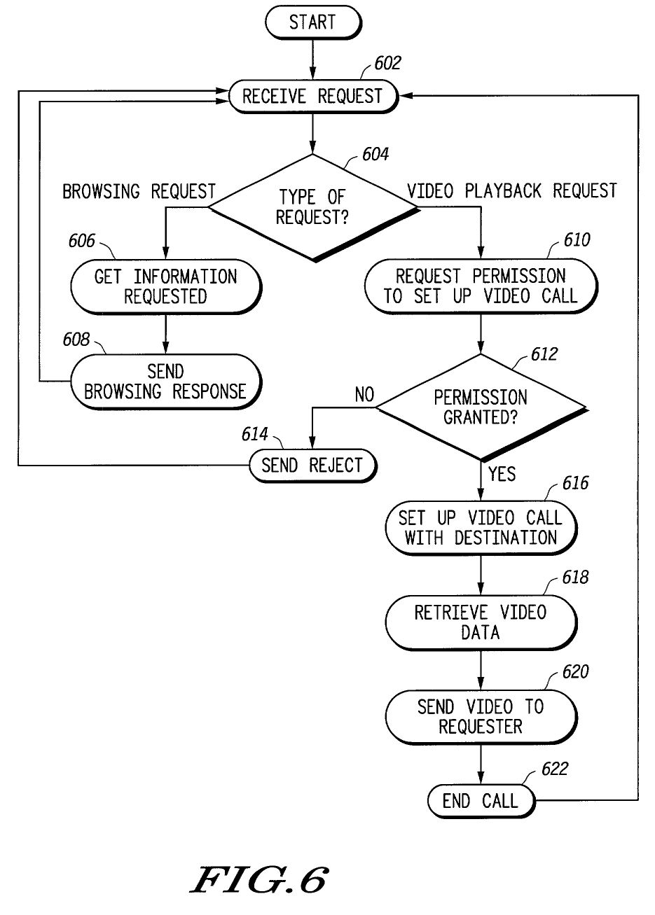

FIG. 5 is a flowchart associated with a wireless terminal of the packet-based multimedia communication system 100. At step 502, the wireless terminal receives downlink data via a wireless link. For example, with reference to FIG. 1, wireless terminal 120 may receive data over wireless link 116. The data may comprise any type of information including, but not limited to assignment(s) granting permission for the wireless terminal to send outbound message(s) over the wireless link and/or inbound message(s) from other devices that are to be presented to the user of the wireless terminal. Generally, the message(s) that may be transmitted in either direction across the wireless link may comprise payload (voice, data, video, etc.) or control messages.

If any data is received at step 502, the wireless terminal determines at step 506 whether the data comprises a Reserved or Non-Reserved Assignment from the wireless link manager associated with the wireless link. If the wireless terminal receives a Reserved Assignment, it determines at step 512 whether it has “reserved data” to send. In one embodiment, reserved data comprises time-critical data such as, for example, data associated with audio and video calls. If it has reserved data to send, it sends the reserved data over the wireless link at step 514. Otherwise, if it doesn't have reserved data to send, it determines at step 508 whether it has “non-reserved data” to send. In one embodiment, non-reserved data comprises non-time-critical data such as, for example, e-mail or file transfers that may be delivered as “best effort” datagrams over the wireless link. If the wireless terminal has non-reserved data to send, it sends the non-reserved data over the wireless link at step 510. If data is received at step 502 that is not a Reserved or Non-Reserved Assignment (e.g., voice, data, or video payload), the data is presented to the user of the wireless terminal at step 520.

After data has been presented to the user at step 520 or sent across the wireless link at steps 510 or 514, or if negative determinations are reached at step 502 or step 508, the wireless terminal determines whether it has received any data from the user of the wireless terminal. The data from the user may comprise, for example, information relating to call requests, web browsing requests, etc. The data may be communicated from the user to the wireless terminal by keypad, touchscreen, menu options, or generally any user-machine interface. If at step 518, the wireless terminal receives data from the user, it processes the data at step 516. For example, the wireless terminal may store the data in a memory buffer and/or prepare the data for sending across the wireless link. After processing the data at step 516, or if a negative determination is reached at step 518, the process returns to step 502.

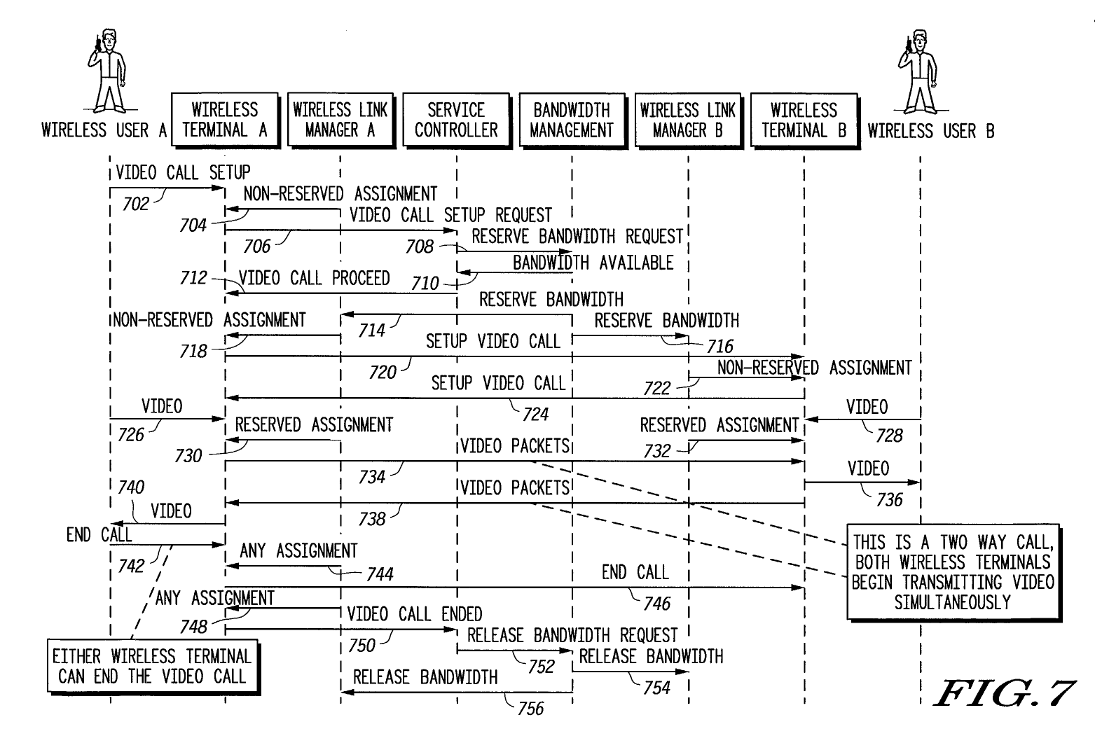

FIG. 6 is a flowchart associated with a multimedia content server of the packet-based multimedia communication system 100. As has been noted, in one embodiment, the multimedia content server comprises a combination of the web server 128 and video server 130 described in relation to FIG. 1. At step 602, the multimedia content server receives a request, from a requesting device, for multimedia information sourced by the multimedia content server to be delivered to a destination device. The requesting and destination devices may comprise the same or different devices, and may comprise any host device of the communication system 100 including, for example, the wireless terminals 120, 122 (or wireless terminals at different sites, not shown in FIG. 1) and/or console 124. In one embodiment, the call request identifies a type of multimedia information (e.g., web browsing information, or stored video information) accessible by the multimedia content server that is to be sent to the destination device.

At step 604, the multimedia content server determines the type of request. In the embodiment of FIG. 6, the request may comprise either a browsing request or a video playback request. As will be appreciated, however, the multimedia content server may include any of several types of multimedia information, in addition to or instead of browsing information and video information, whether devised now or in the future. In such case, the multimedia content server will accommodate different types of requests corresponding to the type of multimedia information that is desired to be retrieved from the multimedia content server. If, at step 604, the request is determined to be a browsing request, the multimedia content server retrieves (or attempts to retrieve) the requested information at step 606 and sends a browsing response at step 608 to the destination device. In one embodiment, the browsing response comprises web browsing information (e.g., relating to a web site), which may comprise, for example, display of web pages, streaming audio and/or video or a message indicating that the web site is not accessible.

If, at step 604, the request is determined to be a video playback request, the multimedia content server requests authorization from the service controller to set up a video call at step 610. The multimedia content server determines at step 612 whether the authorization has been received from the service controller. In one embodiment, as described in relation to FIG. 2, the service controller grants authorization for a call if the source device and destination devices are authorized to participate in the type of service associated with the call and if bandwidth is available to support the call. In the case of a video playback request, authorization for the multimedia content server as a source for the video playback call is substantially guaranteed unless the multimedia content server is out of service or otherwise unable to source video for the call. Thus, in practical effect, authorization for video playback calls will depend primarily on whether the destination device is authorized to receive video playback service and whether there is sufficient available bandwidth between the multimedia content server and the destination device to support the requested video playback service. If authorization is not received for the call, the multimedia content server rejects the call request at step 614 and sends a message to the requesting device accordingly.

If authorization is received for the call, the multimedia content server sets up a one-way video call with the destination device at step 616. The one-way video call may comprise a video-only, or combination video and audio call. In one embodiment, setting up the video call comprises the multimedia content server negotiating terms of the video call with the destination device. For example, the multimedia content server and destination device might negotiate the type of audio, vocoder type, video coder type and/or bit rate to be used for the call. After setting up the call, the multimedia content server retrieves video information (i.e., from memory or from a web site link) associated with the call at step 618 and sends the video information to the requesting device (or destination device, if different than the requesting device) at step 620 until the call ends at step 622.

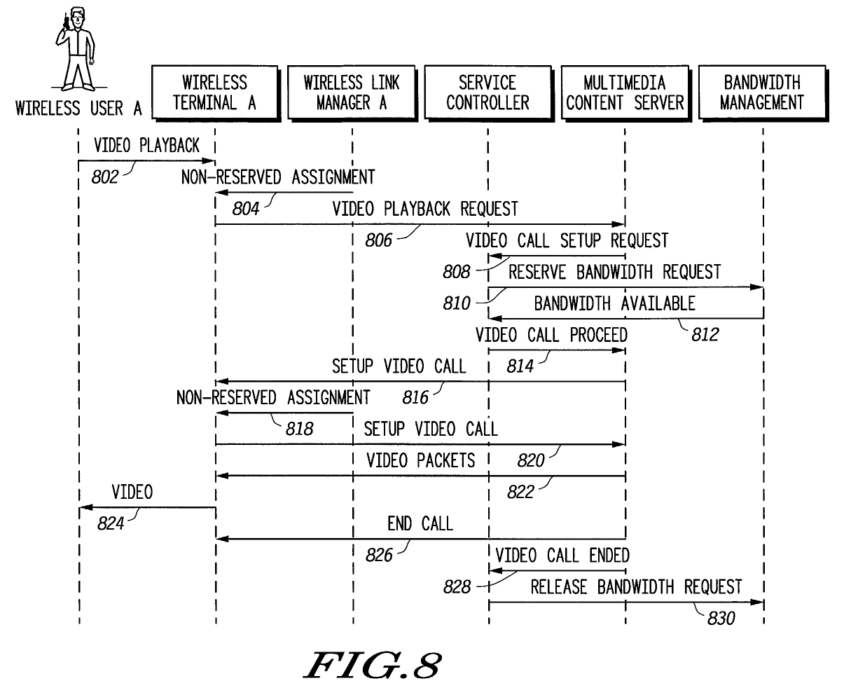

As has been noted, the communication system 100 of the present invention is adapted to support several different types of communication between host devices, including audio and/or video calls requiring registration with the gatekeeper (i.e., the service controller function of the gatekeeper) and communication other than audio and/or video calls (e.g., control signaling, data traffic (including web browsing, file transfers)) that may proceed without registering with the gatekeeper 126. Moreover, as has been noted, the sources and recipients of the different types of communication may comprise wireless devices and/or fixed equipment devices. Examples of various types of communication supportable by the communication system 100 are shown in FIGS. 7-10. More specifically, FIGS. 7-10 are message sequence charts showing examples, respectively, of a two-way video call between wireless terminals; video playback from the multimedia content server to a requesting wireless terminal; video playback from the multimedia content server to a destination wireless terminal (requested by another wireless terminal); and playback of web-browsing content to a requesting wireless terminal. As will be appreciated, however, the communication system of the present invention will support additional and/or different types of communication, including communication with different requesting, source or destination devices than the examples shown in FIGS. 7-10.

It should be noted that the message sequence charts of FIGS. 7-10 use arrows to denote the communication of messages between various host devices of a wireless packet network communication system. However, the arrows do not imply direct communication of the messages between the indicated host devices. On the contrary, many of the messages are communicated between host devices indirectly, through one or more intermediate devices (e.g., routers). For convenience, these intermediate messages are not shown in FIGS. 7-10.

Referring initially to FIG. 7, there is shown a message sequence chart associated with a two-way video call between wireless terminals (“Wireless Terminal A” and “Wireless Terminal B”) located at different sites. The message sequence of FIG. 7 begins with the user of Wireless Terminal A (“Wireless User A”) initiating a video call by sending Video Call Setup signal(s) 702 to Wireless Terminal A. In one embodiment, the Video Call Setup signal(s) 702 identify the type of call and the destination, or second party for the call. Thus, in the present example, the Video Call Setup signal(s) 702 identify the call as a two-way video call and Wireless User B as the destination, or second party for the call. As will be appreciated, the mechanism for entering the Video Call Setup signal(s) 702 will depend on the features and functionality of the wireless terminal(s), and may differ from terminal to terminal. The wireless terminals may include, for example, keypads, touchscreens, menu options, etc. that permit the user to select the type of call and the second party for the call. The second party may be identified by user identification number, telephone number or any suitable means of identification.

As described in detail in related Application Ser. No.______, [docket no. CM04761H], wireless terminal(s) must obtain an assignment of wireless communication resources from an associated wireless link manager before they are allowed to send message(s) across a wireless link. Thus, for example, with reference to FIG. 1, assuming wireless terminal 120 desires to transmit across wireless link 116, it first would obtain an assignment of wireless communication resources from the wireless link manager associated with base station 112. In one embodiment, the assignments comprise either “Non-Reserved Assignments,” meaning that any device is allowed to transmit across the wireless link or “Reserved Assignments” that designate specific device(s) to transmit across the wireless link. In the present example, Wireless Terminal A obtains a Non-Reserved Assignment 704 from its associated wireless link manager (“Wireless Link Manager A”), thereby allowing it to send a Video Call Setup Request 706 across an associated wireless link to the Service Controller. In one embodiment, the Video Call Setup Request 706 includes indicia of the type of call (e.g., a two-way video call) and/or required quality of service for the call that enables the Wireless Link Manager to ascertain the timing and/or type of assignments needed for the call.

The Service Controller, in turn, determines an availability of bandwidth to support the call by sending a Reserve Bandwidth Request 708 to the Bandwidth Manager. In one embodiment, as described in relation to FIG. 3, the Bandwidth Manager responds to the request by determining an amount of bandwidth required on the wireless link(s) required for the call and granting or denying the Reserve Bandwidth Request based on an availability of bandwidth on the wireless link(s). In the example of FIG. 7, the Bandwidth Manager returns a Bandwidth Available message 710 to the Service Controller, indicating that bandwidth is available on the wireless links associated with Wireless Terminals A and B. Having been notified that bandwidth is available, the Service Controller sends a Video Call Proceed message 712 to Wireless Terminal A, thereby authorizing the two-way video call to proceed. The Bandwidth Manager sends Reserve Bandwidth messages 714, 716 to Wireless Link Managers A and B instructing them to reserve bandwidth on the wireless links associated with Wireless Terminals A and B. Messages 712 through 716 may be sent in parallel or in any order.

Of course, if bandwidth is a concern on the wireline link(s) of the communication system 100, the Bandwidth Manager may grant or deny the Reserve Bandwidth Request based on an availability of bandwidth on the wireline and wireless link(s), in which case the Bandwidth Available message 710 would indicating that bandwidth is available on both wireline and wireless links required to support the call request. Further, in addition to instructing Wireless Link Managers A and B to reserve bandwidth on the wireless links, the Bandwidth Manager would instruct Wireline Link Managers (e.g., the routers of the network) to reserve bandwidth on the wireline links required for the call.

In an alternative embodiment, the Wireless Link Managers, rather than the Bandwidth Manager, determine the availability of bandwidth on the wireless link(s). In such embodiment, the Reserve Bandwidth Request 708 would be sent to Wireless Link Managers A and B either directly from the Service Controller or from the Bandwidth Manager. The Wireless Link Managers A and B grant or deny the Reserve Bandwidth Request based on an availability of bandwidth on the wireless link(s) and return appropriate messages (e.g., a Bandwidth Available message, if bandwidth is available) either directly to the Service Controller or to the Bandwidth Manager. Additionally, if bandwidth is a concern on the wireline portion of the network, Wireline Link Managers, rather than the Bandwidth Manager, may determine the availability of bandwidth on the wireline link(s) and grant or deny Reserve Bandwidth Requests based on an availability of bandwidth on the wireline links.

After receiving Non-Reserved Assignments 718, 722 from the respective Wireless Link Managers A and B, Wireless Terminals A and B exchange Setup Video Call messages 720, 724 to negotiate terms of the video call. For example, Wireless Terminals A and B may negotiate the type of audio, vocoder type, video coder type and/or bit rate to be used for the two-way video call.

In one embodiment, video/audio information 726, 728 to be used for the call is obtained by cameras and/or microphones associated with the respective Wireless Terminals A and B operated by the Wireless Users A and B. The video/audio information is converted into IP packets and queued in memory of the respective Wireless Terminals A and B until such time as Reserved Assignments 730, 732 are obtained from the Wireless Link Managers A and B. The Reserved Assignments 730, 732 are adapted to facilitate the transfer of time-critical data, such as IP packets for video/audio calls, over the wireless links associated with the call. Depending on the availability of Reserved Assignments, video/audio packets 734, 738 may be transmitted simultaneously from Wireless Terminal A to B, and from Wireless Terminal B to A. Upon receiving the video/audio packets, Wireless Terminals A and B convert the IP packets into video/audio information 736, 740 that is displayed/communicated to Wireless Users A and B.

In one embodiment, either Wireless User may initiate the end the video call by sending an End Call signal(s) 742 to its Wireless Terminal. In FIG. 7, Wireless User A initiates the end of the video call by sending an End Call signal(s) 742 to Wireless Terminal A. Similar to initiating a start of the video call, the mechanism for Wireless User A entering the End Call signal(s) 742 may comprise, for example, keypads, touchscreens, menu options, etc., depending on the features and functionality of Wireless Terminal A. Upon receiving Any Assignment 744 (i.e., either a Reserved or Non-Reserved Assignment) from Wireless Link Manager A, Wireless Terminal A sends an End Call message 746 to Wireless Terminal B. Additionally, upon receiving a further Any Assignment 748 from Wireless Link Manager A, Wireless Terminal A sends a Video Call Ended message 750 to the Service Controller. As will be appreciated, the call may also end due to conditions such as endpoint shutdown, out-of-range conditions, and the like.

Upon receiving the Video Call Ended message 750, the Service Controller initiates a release of the bandwidth supporting the call by sending a Release Bandwidth Request 752 to the Bandwidth Manager. The Bandwidth Manager releases the bandwidth in generally the reverse fashion that it obtained reservations of bandwidth, via respective messages 754, 766 either instructing or requesting the Wireless Link Managers A and B to release the bandwidth supporting the two-way video call.

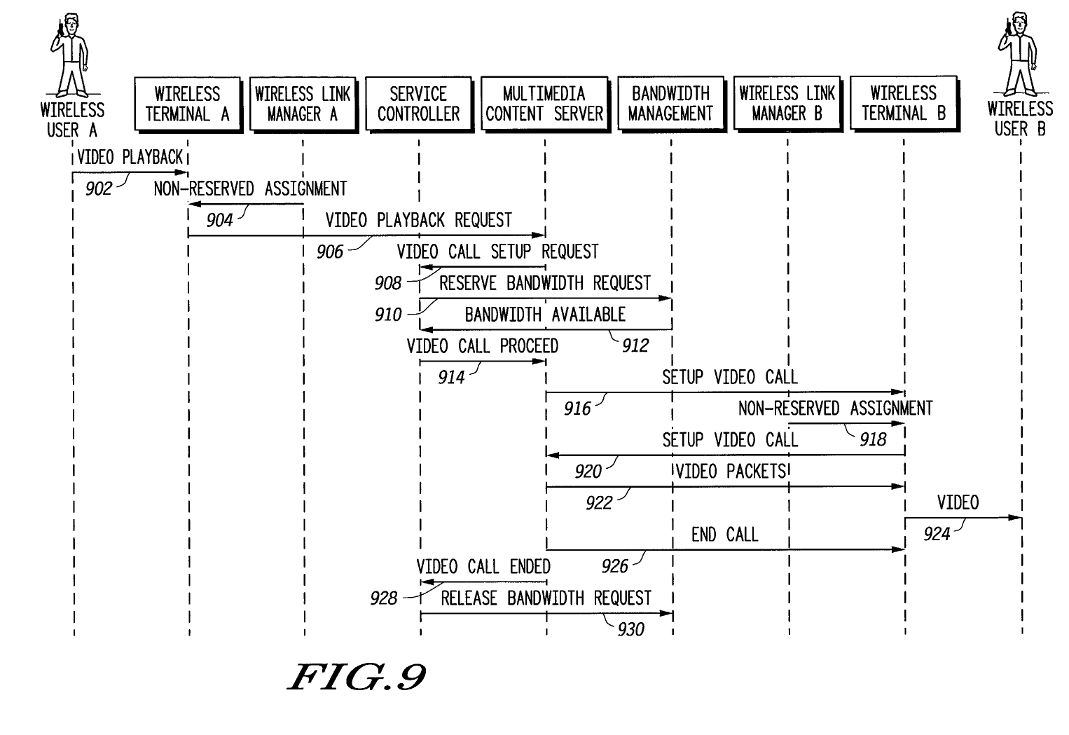

Now turning to FIG. 8, there will be described a message sequence associated with a video playback request. In one embodiment, video playback calls define one-way audio and video calls sourced from a multimedia content server and delivered to a destination device specified in the request. Alternatively or additionally, the multimedia content server may source audio-only, video-only, or lip-synced audio and video streams. The message sequence of FIG. 8 begins with the user of Wireless Terminal A (“Wireless User A”) initiating the request by sending Video Playback signal(s) 802 to Wireless Terminal A. In one embodiment, the Video Playback signal(s) 702 identify the video information (e.g., video clips) that is desired for playback in a manner that is recognizable by the multimedia content server, such that the multimedia content server may ultimately retrieve and source the requested video information. For example, the Video Playback Signal(s) may identify a URL for a particular web site video link. The Video Playback Signal(s) 702 also identify the destination for the call, which in the present example is the requesting device (Wireless User A). However, the destination device may be different than the requesting device, as will be shown in FIG. 9. The mechanism for Wireless User A entering the Video Playback signal(s) 802 may comprise, for example, keypads, touchscreens, menu options, and the like, depending on the features and functionality of Wireless Terminal A.

Next, Wireless Terminal A obtains a Non-Reserved Assignment 804 from Wireless Link Manager A, thereby allowing it to send a Video Playback Request 806 across an associated wireless link to the Multimedia Content Server. The Multimedia Content Server, which is the source of video information for the call, sends a Video Call Setup Request 808 to the Service Controller. The Service Controller determines an availability of bandwidth to support the call by sending a Reserve Bandwidth Request 810 to the Bandwidth Manager. The Bandwidth Manager responds to the request by determining an amount of bandwidth required for the call and granting or denying the Reserve Bandwidth Request based on an availability of bandwidth for the call. In one embodiment, as described in relation to FIG. 3, the Bandwidth Manager responds to the request by determining an amount of bandwidth required on the wireless link(s) required for the call and granting or denying the Reserve Bandwidth Request based on an availability of bandwidth on the wireless link(s). In the example of FIG. 8, the Bandwidth Manager returns a Bandwidth Available message 812 to the Service Controller, indicating that bandwidth is available on Wireless Link A to support the video playback call. The Service Controller, in turn, sends a Video Call Proceed message 814 to the Multimedia Content Server, thereby authorizing the video playback call to proceed.

Thereafter, the Multimedia Content Server and Wireless Terminal A exchange Setup Video Call message(s) 816, 820 to negotiate terms of the video call such as, for example, the type of audio, vocoder type, video coder type and/or bit rate to be used for the video playback call. In one embodiment, the Setup Video Call message(s) 820 from Wireless Terminal A can not be sent until Non-Reserved Assignment(s) 818 are received from Wireless Link Manager A. After terms of the video playback call have been negotiated, the Multimedia Content Server retrieves video/audio packets 822 from memory or from an associated web server and sends them to Wireless Terminal A. Upon receiving the video/audio packets, Wireless Terminal A converts the IP packets into video/audio information 824 that is displayed/communicated to Wireless User A.

When the Multimedia Content Server has finished sending the video/audio packets 822, it ends the video playback call by sending End Call message(s) 826 to Wireless Terminal A and Video Call Ended message(s) 828 to the Service Controller. Upon receiving the Video Call Ended message 828, the Service Controller initiates a release of the bandwidth supporting the call by sending a Release Bandwidth Request 830 to the Bandwidth Manager.

FIG. 9 is a message sequence chart associated with a video playback request wherein the destination device is different than the requesting device. The message sequence of FIG. 9 otherwise is generally the same as FIG. 8. Wireless User A initiates the request by sending Video Playback signal(s) 902 to Wireless Terminal A. The Video Playback signal(s) 902 identify the video information (e.g., video clips) that is desired for playback in a manner that is recognizable by the multimedia content server, such that the multimedia content server may ultimately retrieve and source the requested video information. For example, the Video Playback Signal(s) may identify a URL for a particular web site video link. The Video Playback Signal(s) 902 also identify the destination for the call, which in the present example is Wireless User B, located at a different RF site than Wireless User A. The mechanism for Wireless User A entering the Video Playback signal(s) 902 may comprise, for example, keypads, touchscreens, menu options, and the like, depending on the features and functionality of Wireless Terminal A.

Wireless Terminal A obtains a Non-Reserved Assignment 904 from Wireless Link Manager A and sends a Video Playback Request 906 across an associated wireless link to the Multimedia Content Server. The Multimedia Content Server, which is the source of video information for the call, sends a Video Call Setup Request 908 to the Service Controller. The Service Controller determines an availability of bandwidth to support the call by sending a Reserve Bandwidth Request 910 to the Bandwidth Manager. The Bandwidth Manager responds to the request by determining an amount of bandwidth required for the call and granting or denying the Reserve Bandwidth Request based on an availability of bandwidth for the call. In the example of FIG. 9, the Bandwidth Manager returns a Bandwidth Available message 912 to the Service Controller, indicating that bandwidth is available to support the video playback call. The Service Controller, in turn, sends a Video Call Proceed message 914 to the Multimedia Content Server, thereby authorizing the video playback call to proceed.

Thereafter, the Multimedia Content Server and Wireless Terminal B exchange Setup Video Call message(s) 916, 920 to negotiate terms of the video call such as, for example, the type of audio, vocoder type, video coder type and/or bit rate to be used for the video playback call. In one embodiment, the Setup Video Call message(s) 920 from Wireless Terminal B can not be sent until Non-Reserved Assignment(s) 918 are received from Wireless Link Manager B. After terms of the video playback call have been negotiated, the Multimedia Content Server retrieves video/audio packets 922 from memory or from an associated web server and sends them to Wireless Terminal B. Upon receiving the video/audio packets, Wireless Terminal B converts the IP packets into video/audio information 924 that is displayed/communicated to Wireless User B.

When the Multimedia Content Server has finished sending the video/audio packets 922, it ends the video playback call by sending End Call message(s) 926 to Wireless Terminal B and Video Call Ended message(s) 928 to the Service Controller. Upon receiving the Video Call Ended message 928, the Service Controller initiates a release of the bandwidth supporting the call by sending a Release Bandwidth Request 930 to the Bandwidth Manager.

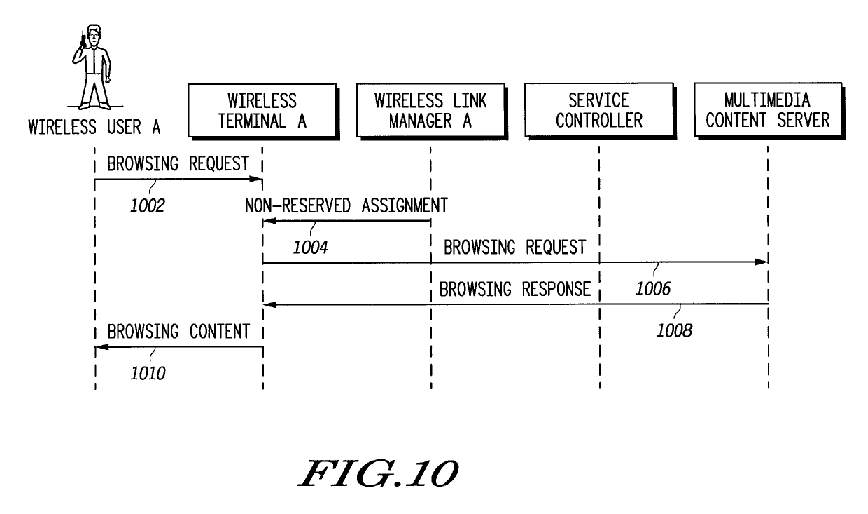

FIG. 10 is a message sequence chart associated with a web browsing request from a wireless terminal (Wireless User A). Wireless User A initiates the request by sending Browsing Request signal(s) 1002 to Wireless Terminal A. The Browsing Request signal(s) 1002 identify the web browsing information (e.g., web sites, URLs) that are desired to be accessed by Wireless User A. The Browsing Request Signal(s) 1002 also identify the destination for the call, which in the present example is Wireless User A. However, the destination device may be different than the requesting device. The mechanism for Wireless User A entering the Browsing Request signal(s) 1002 may comprise, for example, keypads, touchscreens, menu options, and the like, depending on the features and functionality of Wireless Terminal A.

Wireless Terminal A obtains a Non-Reserved Assignment 1004 from Wireless Link Manager A and sends a Browsing Request 1006 across an associated wireless link to the Multimedia Content Server. The Multimedia Content Server sends a Browsing Response signal 1008 to Wireless Terminal A that includes browsing information associated with the browsing request. Upon receiving the browsing information, Wireless Terminal A displays Browsing Content 1010 to Wireless User A.

The present disclosure therefore has identified a communication system that extends packet transport service over both wireline and wireless link(s). The communication system supports high-speed throughput of packet data, including but not limited to streaming voice and video to wireless terminals participating in two-way video calls, video playback calls, and web browsing requests.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is: [System—focus on service controller]

1. A communication system comprising:
a wireless packet network;
a plurality of host devices coupled to the wireless packet network, the plurality of host devices including at least a source device and a destination device; and
a service controller, coupled to the wireless packet network and in communication with the plurality of host devices, for managing one or more communications services between the source device and destination device over the wireless packet network.

2. The system of claim 1, wherein the wireless packet network comprises a packet network having at least one wireless link.

3. The system of claim 1, wherein the one or more communications services are selected from the group consisting of: voice calls, video calls, web browsing, video-conferencing and internet communications.

4. The system of claim 1, wherein the source device and the destination device comprise wireless terminals.

5. The system of claim 1, wherein the source device comprises a video server and the destination device comprises a wireless terminal.

6. The system of claim 1, wherein the source device comprises a web server and the destination device comprises a wireless terminal.

7. The system of claim 1, wherein the source device comprises an IP gateway and the destination device comprises a wireless terminal.
[System—combination of service controller, multimedia content server, BW mgt element, wireless link mgr]

8. A communication system comprising:
a wireless packet network;
a multimedia content server coupled to the wireless packet network and having access to one or more requested multimedia communication services;
a service controller, operably connected to the multimedia content server, for managing service requests associated with the one or more requested multimedia communication services;
a bandwidth manager, operably coupled to the service controller, for determining an availability of bandwidth for the service requests and, if bandwidth is available, reserving bandwidth sufficient to support the service requests; and
a wireless link manager, operably coupled to the bandwidth manager, for managing wireless communication resources required to support the service requests.

9. The communication system of claim 8, wherein the service controller and bandwidth manager are embodied within a gatekeeper device coupled to the wireless packet network.
[Method—Service Controller]

10. In a communication system including a service controller coupled to a wireless packet network, a method comprising the service controller performing the steps of:
receiving, from a requesting device, a call request for a type of video/audio call;
identifying a source and destination device associated with the call;
requesting a reservation of bandwidth to support the call;
if the reservation is available, authorizing the call to proceed; and
if the reservation is not available, rejecting the call request.

11. The method of claim 10, comprising the service controller performing the further steps of:
determining whether the source device is authorized to participate in the call; and
if the source device is not authorized to participate in the call, rejecting the call request.

12. The method of claim 10, comprising the service controller performing the further steps of:
determining whether the destination device is authorized to participate in the call;
if the destination device is not authorized to participate in the call, rejecting the call request.

13. The method of claim 10, wherein the call request is for a type of call selected from the group consisting of: two-way video, one-way video, two-way audio, one-way audio, two-way audio and video, and one-way audio and video calls.

14. The method of claim 10 comprising, upon authorizing the call to proceed:
receiving, by the service controller from the source and destination devices, periodic messages indicative of call activity; and
determining that the call is ended upon the service controller failing to receive the periodic messages for a designated time period.

15. The method of claim 10 comprising, upon authorizing the call to proceed:
monitoring, by the service controller, a duration of the call; and
ending the call, if the service controller determines the duration of the call exceeds an allowable time limit.
[Method—Multimedia Content Server]

16. In a communication system including a multimedia content server coupled to a wireless packet network, a method comprising the multimedia content server performing the steps of:
receiving, from a requesting device, a request for multimedia information to be delivered to a destination device;
retrieving the requested multimedia information; and
sending the requested multimedia information to the destination device.

17. The method of claim 16, wherein the request for multimedia information comprises a web browsing request, the step of sending requested multimedia information comprising sending web browsing information from the multimedia content server to the destination device.

18. The method of claim 16, wherein the request for multimedia information comprises a video playback request, the step of sending requested multimedia information comprising sending stored video information from the multimedia content server to the destination device.

19. The method of claim 18 comprising, prior to the multimedia content server sending stored video information to the destination device:
requesting, by the multimedia content server from a service controller, authorization for a video call; and
if authorization is received, negotiating terms of sending the stored video information to the destination device.

20. The method of claim 19, wherein the step of negotiating terms of sending the stored video information comprises negotiating one or more of: type of audio, vocoder type, video coder type and bit rate associated with the stored video information.
[BW manager]

21. In a communication system including a bandwidth manager coupled to a wireless packet network, a method comprising the bandwidth manager performing the steps of:
receiving, from a requesting device, a request for a reservation of bandwidth to support a video/audio call;
determining an amount of bandwidth required for the call;
if the amount of bandwidth is available, granting the reservation; and
if the amount of bandwidth is not available, denying the reservation.

22. The method of claim 21 wherein the requesting device comprises a service controller operably coupled to the bandwidth manager.

23. The method of claim 21 wherein the step of granting the reservation comprises:
reserving wireless communication resources with an associated one or more wireless link managers; and
sending, to the requesting device, a message indicating an availability of the amount of bandwidth required for the call.

24. The method of claim 23, further comprising the step of reserving wireline communication resources to support the call.

25. The method of claim 23, wherein the step of reserving wireless communication resources comprises the bandwidth manager commanding the one or more wireless link managers to reserve the wireless communication resources.

26. The method of claim 23, wherein the step of reserving wireless communication resources comprises:
sending, from the bandwidth manager to the one or more wireless link managers, a request for a reservation of the wireless communication resources;
determining, by the one or more wireless link managers, an availability of the requested wireless communication resources; and
if the wireless communication resources are available,
granting, by the one or more wireless link managers, the request for reservation of wireless communication resources.

27. The method of claim 21, comprising the bandwidth manager performing the further steps of:
receiving, from the requesting device, a request for a release of bandwidth associated with a video/audio call;
determining an amount of wireless communication resources associated with the request; and
releasing the wireless communication resources associated with the request.

28. The method of claim 27, wherein the step of releasing the wireless communication resources comprises the bandwidth manager commanding one or more wireless link managers to release the wireless communication resources.

29. The method of claim 27, wherein the step of releasing the wireless communication resources comprises the bandwidth manager requesting, from one or more wireless link managers, a release of the wireless communication resources.
[video playback]

30. In a wireless packet network communication system including a video server, a method comprising the video server performing the steps of:
receiving, from a requesting device, a request for video playback to a destination device;
requesting, from a service controller, authorization for video playback of one or more packets of video information associated with the request, to the destination device; and
if authorization is received, retrieving the one or more packets of video information and sending the one or more packets to the destination device.

31. The method of claim 30, comprising the service controller performing the steps of:
requesting a reservation of bandwidth to support the video playback;
if the reservation of bandwidth is received, granting authorization for the video playback.

32. The method of claim 30, wherein the requesting device and the destination device comprise the same device.

33. The method of claim 32, wherein the device comprises a wireless terminal operably coupled to the video server.

34. The method of claim 30, wherein the requesting device and the destination device comprise different devices.

35. The method of claim 34, wherein the different devices comprise first and second wireless terminals operably coupled to the video server.
[2-way video call]

36. In a communication system including a first and second wireless terminal operably connected to a service controller via a wireless packet network including one or more wireless links, a method comprising:
receiving, by the service controller from the first wireless terminal, a call request for a two-way video call with the second wireless terminal;
determining, by the service controller, an availability of bandwidth to support the call;
in response to a positive determination of availability, sending, from the service controller to the first wireless terminal, a message authorizing the call to proceed.

37. The method of claim 36, wherein the communication system includes a bandwidth manager operably coupled to the service controller, the step of determining an availability of bandwidth comprising:
sending, from the service controller to the bandwidth manager, a request for a reservation of bandwidth to support the call;
determining, by the bandwidth manager, an amount of bandwidth required for the call; and
if the amount of bandwidth is available, sending, from the bandwidth manager to the service controller, a message indicating an availability of the amount of bandwidth required for the call.

38. The method of claim 36, further comprising, if the call is authorized to proceed,
receiving, by the first wireless terminal, an assignment granting permission to send information over a first wireless link;
receiving, by the second wireless terminal, an assignment granting permission to send information over a second wireless link;
sending one or more video packets from the first wireless terminal to the second wireless terminal; and
sending one or more video packets from the second wireless terminal to the first wireless terminal.

39. The method of claim 38 comprising, prior to sending one or more video packets by either of the first and second wireless terminals, negotiating terms of sending the one or more video packets between the first and second wireless terminals.
[Wireless Terminal]

40. In a communication system including a wireless terminal operably coupled to a wireless packet network, a method comprising the wireless terminal performing the steps of:
receiving information via a wireless link, the information comprising one of:
an assignment granting permission for the wireless terminal to send an inbound message over the wireless link; and
an outbound message to be presented to a user of the wireless terminal;
if the information is an assignment, sending the inbound message over the wireless link; and
if the information is an oubound message, presenting the outbound message to the user.

41. The method of claim 40, wherein the step of receiving information comprising an assignment comprises receiving one of: a reserved assignment and a non-reserved assignment.
